(19) United States
(12) Patent Application Publication
(10) Pub. No.: US 2004/0134478 A1
(43) Pub. Date: Jul. 15, 2004

(54) Aggregate cutting saw chain

(76) Inventor: Charles M. Bailey, Clackamas, OR (US)

Correspondence Address: Robert L. Harrington, Schwabe Williamson & Wyatt, Suite 1900, 1211 SW Fifth Avenue, Portland, OR, 97204, US

(21) Appl. No.: 10/340,513

(22) Filed: Jan. 9, 2003

(51) Int. Cl. B28D 1/08; B28D 1/12

(52) U.S. Cl. 125/21; 125/22

(57) ABSTRACT

A saw chain for cutting aggregate material having cutting segments wherein diamonds are embedded in a matrix material, said cutting of an aggregate structure achieved by drawing the segment across the aggregate structure with the diamonds exposed so as to abrade away the aggregate material producing thereby a kerf. The diamonds initially being unexposed and requiring an initial abrasion of the matrix material surrounding the diamonds. The surface of the cutting head having a peak portion whereby minimal abrading of the matrix in the peak portion rapidly exposes diamonds to commence the abrasion of the aggregate.

### FIELD OF THE INVENTION

This invention relates to a saw chain that is mounted on a chain saw and used for cutting aggregate structures such as concrete, and more particularly it relates to the cutting segment of the saw chain.

### BACKGROUND OF THE INVENTION

This invention is primarily directed to a specific problem involving the cutting segments or segments of the aggregate cutting saw chain. The segments are block-like members secured to the top edges of opposed side links and are pressed into contact with an aggregate structure, e.g., concrete or stone. The segments include abrading elements, e.g., industrial diamonds, that are dispersed in a matrix substrate. The matrix substrate does not perform the cutting operation but necessarily performs the task of securing the diamonds to the segment. The diamonds that are exposed at the surface of the matrix grind through the aggregate, the grinding wears (or fractures or displaces) the exposed diamonds and in the process removes the topmost matrix material which exposes more underlying diamonds. This process is repeated and the result is cutting by the chain into and through aggregate structures until the segment is depleted.

The problem referred to concerns the startup of the cutting operation using a new cutting chain. The segments as initially produced have a smooth outer cutting surface at which point none of the diamonds within the segments are exposed for cutting. Such a chain when presented to the aggregate material in a cutting operation performs little cutting action for a period of time. The primary effect of the initial cutting action is to wear away the matrix until there is sufficient exposure of the outermost or topmost diamonds. The segments have length, e.g., ⅝-inch and width, e.g., ¼-inch and flat or near flat outer face, i.e., top surface and it takes precious minutes of wearing action before any significant cutting of the concrete structure can take place. Such is undesirable and is addressed by the present invention.

It needs to be understood however that the cutting life of the segments and thus the cutting chain is a factor of the volume of the segment that is available for cutting. Thus a volume of a segment that is ⅝″×¼″×¼″ will have a cutting life greater than a segment that is ⅜″×¼″×⅛″, for example. Thus it is not desirable to simply modify the dimensions of the segment. The width of the segment is essentially that which is necessary to develop a kerf width that allows passage of the chain and guide bar and the height is established based on operation efficiencies.

### BRIEF DESCRIPTION OF THE INVENTION

The preferred embodiment of the present invention is intended to avoid reducing cutting life while accelerating the break-in time as needed to achieve a cutting configuration for the segment (i.e., exposure of the diamonds). This is accomplished in the preferred embodiment by modifying the front to back profile of the top surface of the segment. The segment is produced to have a shallow inverted “v” shape extended above a true flat surface area and referred to as a zone of reduced area of engagement. The apex of the “v” being the outermost point initially engages the aggregate structure to be cut and is extended above the true flat surface area by at least 0.025″, e.g., 4% of a ⅝″ length of the segment. The volume is not changed as the center is slightly raised to add material and tapered to the front and rear ends, making the ends lower than the segments of prior aggregate saw chain but resulting in little or no change in volume.

Whereas the diamonds are nevertheless embedded under the surface of the matrix, the wearing of the matrix occurs rapidly at the peak to expose the diamonds for cutting with little lag or non-productive time. Thereafter, as the exposed diamonds at the peak are worn, the matrix extended forward and rearward of the peak portion also wears away to expose more diamonds and the process continues until the entire top surface participates in the cutting action.

A further benefit is achieved in that the front end of the segment at startup is lowered as compared to the cutting links commonly used and such reduces the occurrence of snagging, i.e., wherein the leading edge of the segments impacts the concrete/aggregate as the chain rounds the bar nose.

### BRIEF DESCRIPTION OF THE FIGURES

FIG. 1 is a perspective view of an aggregate cutting chain in accordance with the invention;

FIG. 2 is a top view of the chain of FIG. 1;

FIG. 3 is a side view of the chain of FIG. 1;

FIG. 4 is a section view as taken on view lines 4-4 of FIG. 3;

FIG. 5a is a schematic illustration of an upper section of a segment of the present invention;

FIG. 5b is a schematic illustration of an upper section of a segment of the prior art;

FIGS. 6a-6i schematically illustrate alternative embodiments of the invention;

FIG. 7 provides a comparison of a prior art chain and the chain of FIG. 1;

FIGS. 8 and 9 illustrate a perspective view alternate embodiments of the invention.

### DETAILED DESCRIPTION OF THE PREFERRED EMBODIMENT

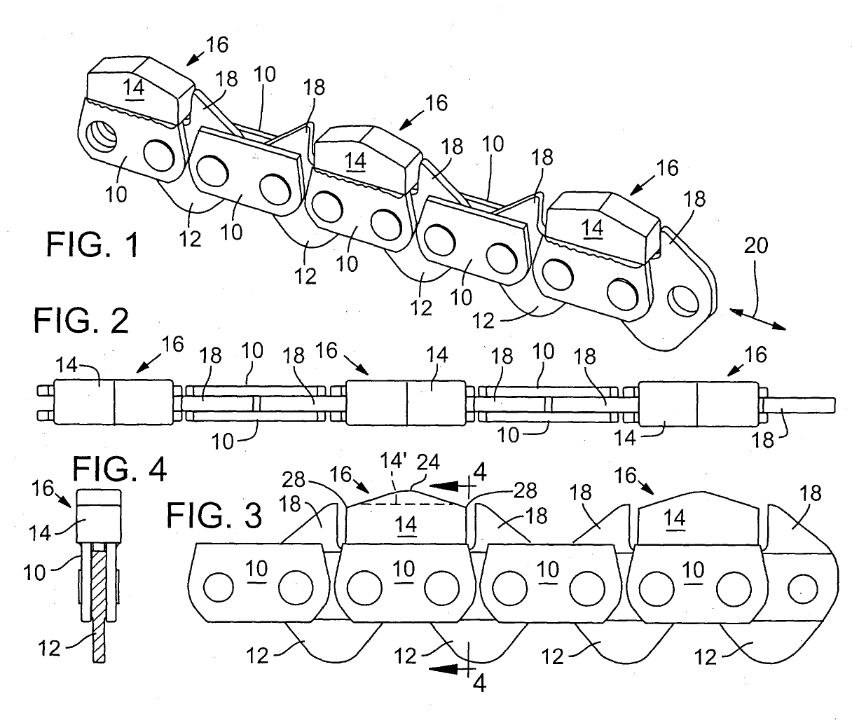

Reference is made to FIGS. 1-4 which illustrate a preferred embodiment of the invention. The illustrated saw chain is comprised of side link pairs 10 and drive/center links 12. Alternate side link pairs are provided with cutting segments 14 which in combination make up cutters 16. The drive links 12 are provided with inclining guard extensions 18 at one side, the drive links 12 being alternately reversed so that a guard extension 18 is placed forwardly and rearwardly of the segment 14. Accordingly, the guard extensions 18 provide an inclining guard portion preceding the segment 14 in either direction of cutting as indicated by double-headed arrow 20. (Such cutting chains alternatively are provided to travel in one direction only and will have the inclining guard portion only on the leading drive link.)

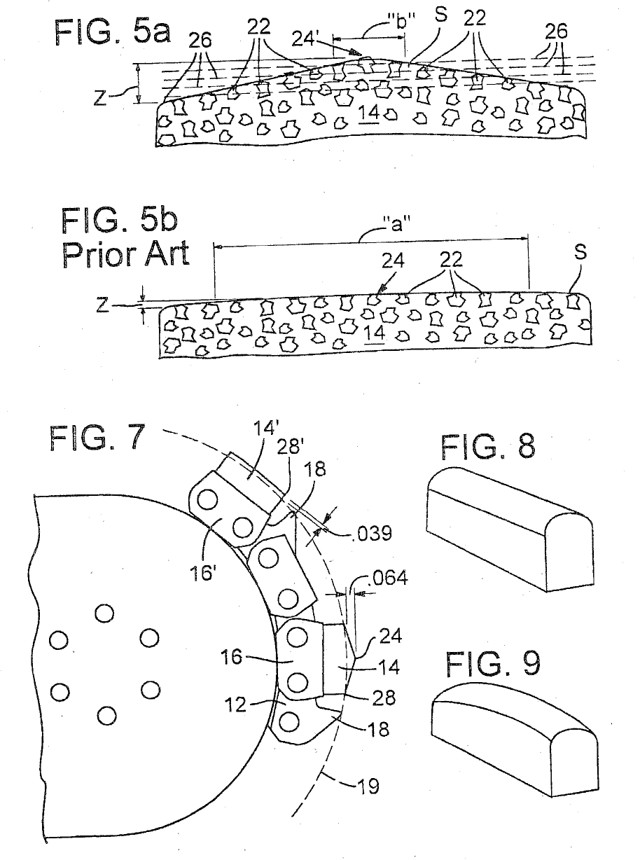

With specific reference to FIG. 3, the side profile of the upper surface of the cutting segment 14 is illustrated in full lines with a prior art profile 14′ depicted in dash line. FIG. 5a schematically illustrates the wearing pattern for the solid line cutting segment 14 and FIG. 5b for the dash line segment 14′. Added to the views of FIGS. 5a and 5b are outlines which represent diamonds 22 (or similar abrading elements) embedded under the surface S of the matrix.

During the initial startup of a new cutting chain having unused cutting segments 14, it is necessary to first wear down the matrix in which the diamonds are embedded to expose a portion of the diamonds as needed for cutting. To achieve a desired cutting by the diamonds, about 50% of the diamond needs to be exposed, but some cutting takes place at as little as 20% exposure. A typical diamond for this preferred embodiment is about 0.015″ in diameter. However, the diamonds (as shown) are not necessarily consistent in size, they are not necessarily symmetrical, and the stated 0.015″ dimension is substantially an average size for the diamonds being used. The actual sizes can range from 0.002″-0.050″ but more typically are in the range of 0.008″-0.025″.

Reference is now made to FIG. 5b which schematically illustrates a typical profile of a prior art cutting segment that is slightly convex and which assumes a diamond 22 to be embedded at or near the peak 24. It will be noted that a substantial length of the matrix of the cutting head/segment, i.e., length “a” has to be worn down before 50% of the topmost diamond 22 is exposed at peak 24. With reference to FIG. 5a and again assuming a diamond embedded at the peak 24′, due to the increased angle of surface S (a higher peak 24′), the topmost diamond 22 is exposed to the 50% level for desired cuttting with far less removal of the matrix, i.e., length “b”. In practice and with reference to 5a, it will be appreciated that the matrix material within length “b” will very rapidly wear to expose the topmost diamond 22 for cutting (e.g., 50% exposure), and at that point satisfactory cutting of the aggregate will take place. Because only a few of the diamonds (across the segment width) will be involved in the cutting action, these diamonds will wear (fracture or pop out) quite rapidly but in the process more matrix material will be removed and more diamonds will be exposed as indicated by the multiple wear lines 26. Hereafter the distance between the highest point or peak 24/24′ and a “worn flat” condition will be referred to as a zone of reduced area of engagement (“zone Z”)

Whereas the preferred embodiment of FIGS. 1-4 (and 5a) illustrate a symmetrical shape having a peak 24′ and declining forward and rearward sides sloping away from the peak, other shapes are contemplated. First it will be explained that a benefit of the invention is the rapid exposure of the diamonds at startup and thereby the rapid initiation of the cutting action when breaking in a new chain. This is achieved by providing a shortened section (“b”) of the cutting head jutting outwardly from the top of the cutting head whereby a reduced wearing of matrix material is required before the diamonds begin the cutting action.

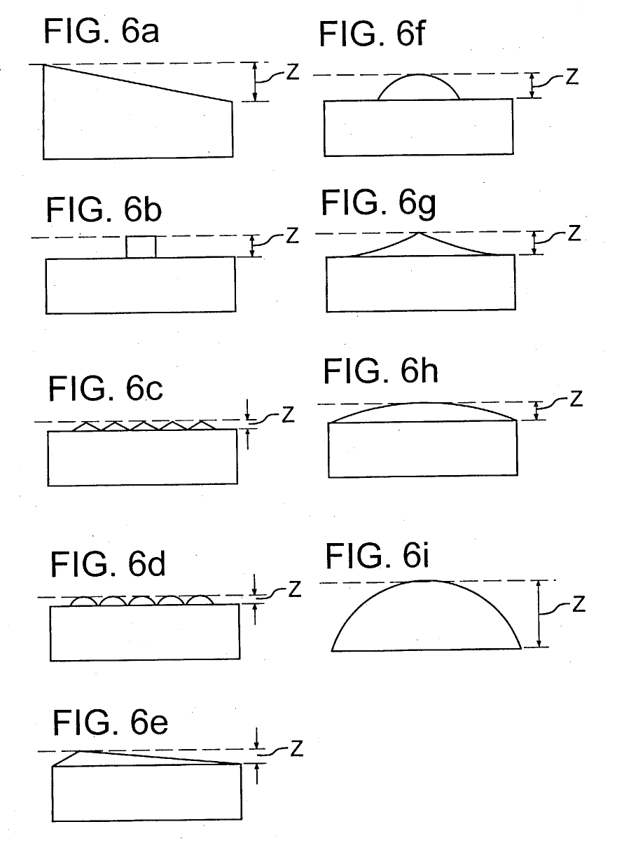

The preferred embodiment described above is believed to achieve this benefit most efficiently. However, it is recognized that other forms will achieve similar benefits. Several are illustrated in FIGS. 6a-6i. Each of these variations produces a zone Z of reduced area of engagement and thus a reduced wearing of the matrix material before the desired cutting action takes place. Such are considered to be alternate embodiments of the invention, i.e., when zone Z is 0.025 inch or greater.

It is considered that the invention is satisfied by a cutting head or segment configuration that substantially reduces the surface area required to be ground or worn down in the startup mode, i.e., until reaching an exposure of the topmost diamonds as required for cutting. This substantial reduction can be described as a surface area configuration for the segment which produces high and low areas. Only the high areas are engaged during initial segment engagement with the aggregate structure and thus the embedded diamonds in the high areas become exposed more rapidly and accordingly the cutting action commences more rapidly. More specifically, it is understood that the invention is satisfied when any quantity of the top surface of the segment falls outside of the parallel planes which are 0.025 inches or greater apart.

Whereas segments are presently produced that are not truly flat topped (i.e., slightly convex), the slight difference between the highest point and a flat surface (i.e., from where the segment top is worn down to a flat surface) is so minimal that little or not benefit is recognizable to the user (see FIG. 5b). It is considered that any height differential that does not exceed 0.025″ from the highest point to the flat surface condition of a typical segment, does not provide the desired benefit. The typical segment is ⅝″ or 0.625″ in length and the 0.025″ zone height is 4% of the segment length. Alternatively, the lengths “a” and “b” can be viewed as a percentage of the flat top surface area and it is determined that this percentage should be less than 50% and preferably no greater than 30% of the flat top surface area for the preferred embodiment.

Reference is again made to FIG. 3 wherein it will be noted for the far-left cutting head that the profile of a segment of a prior art flat topped segment is shown in dash lines. It will be appreciated that the leading and trailing edges of the segment 14 of the preferred embodiment (in solid lines) are lower than the prior art segment (dash lines) while the peak 24 is extended above the highest point of the prior art segment. This configuration of the preferred embodiment provides substantially the same volume of segment material and whereas the operational life of the segment is based on the volume of the segment that is available for cutting action, these segments have similar operational life.

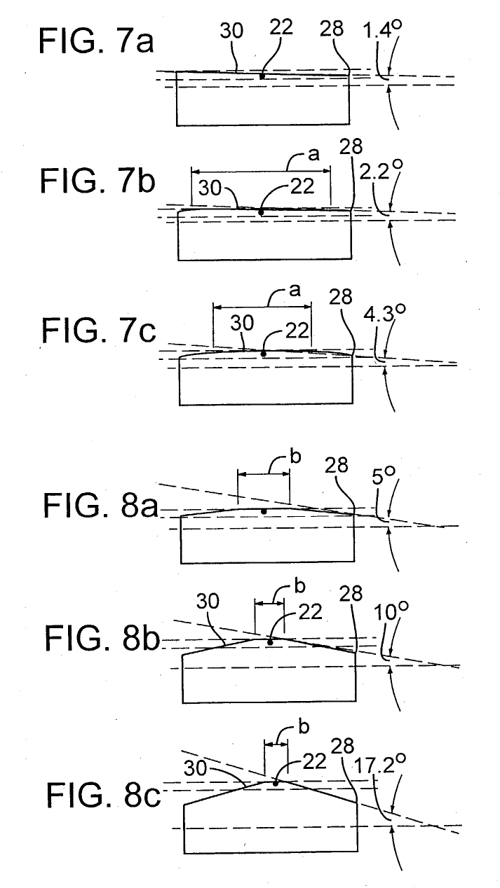

It will also be noted from FIG. 3 that the leading edge 28, regardless of the direction of travel, lies below the peak of guard extensions 18. This lowering of the leading edge provides an additional advantage particularly as the cutting length 16 travel around the nose of the guide bar as illustrated in FIG. 7. FIG. 7 untypically illustrates both a prior art segment 14′ and a segment 14 of the present invention. As shown in FIG. 7, adjoining links 16 and 12 when rounding the bar nose, particularly at the outer reaches, e.g., as between the tip of the guard extension 18 and the leading edge 28 of the segment, spread apart. With the leading edge 28 of the segment 14 both lowered and inclined, the occurrence of snagging, i.e., where the leading edge tends to dig into the structure being cut, is substantially lessened (e.g., compare prior art leading edge 28′ of segment 14′ with leading edge 28 of segment 14). The path 19 taken by the tip of the guard extension 18 is the same height as leading edge 28 and lower (distance 0.039) than the leading edge 28′. Yet because of the peak 24 being higher than that of the prior art cutter 14′ (distance 0.064), more cutting takes place. This benefit continues for the cutting segment of the present invention both during and for some period following the breaking in of a new chain of the invention.

Whereas a number of variations have been illustrated, they are but examples of what a person skilled in the art may conceive of upon exposure to the basic concept of the invention as disclosed herein. For example, consider that a similar reduction in the surface area can be achieved by rounding or angling a surface area side to side instead of in addition to rounding or angling the surface area front to back, e.g., see FIGS. 8 and 9. Again, whether it be front to back or side to side, it is considered that the invention is satisfied when any quantity of the top surface of the segment falls outside of the two parallel planes 0.025 inches apart. Accordingly, the invention is considered to encompass a zone of reduced surface area of engagement for more rapid break-in of a new aggregate cutting chain regardless of the surface configuration, and such is intended to be defined by the appended claims.

The invention claimed is:

1. An aggregate cutting saw chain for cutting aggregate structures comprising:
a segment defining a length and a width and having abrading elements embedded in a matrix material and adapted to be secured to upper edges of a carrier link or side links of the saw chain;
said segment as secured to said carrier link or side links and in unused condition having an upper surface of non-flat surface configuration varying in height to provide higher and lower surface areas and which wears during use to a flat surface configuration, said upper surface of= non-flat configuration and continuing to said flat surface configuration defining a zone of reduced area of engagement;
said abrading elements dispersed throughout the matrix material and in unused condition lying under the upper surface of non-flat surface configuration, said abrading elements in the higher surface area or areas exposed for cutting as the matrix material at said higher surface area or areas is removed in an initial cutting operation, said zone of reduced area of engagement having a height at startup of at least 4% of the cutter length.

2. An aggregate cutting saw chain for cutting aggregate structures comprising:
a segment defining a length and a width and having abrading elements embedded in a matrix material and adapted to be secured to upper edges of a carrier link or links of the saw chain;
said segment as secured to said carrier link or side links and in unused condition having an upper surface of non-flat surface configuration varying in height to perform higher and lower surface areas and which wears during use to a flat surface configuration, said upper surface non-flat configuration and continuing to said flat surface configuration defining a zone of reduced area of engagement;
said abrading elements dispersed throughout the matrix material and in unused condition lying under the upper surface of non-flat surface configuration, said abrading elements in the higher surface areas exposed for cutting as the matrix materials at said higher surface areas is removed in an initial cutting operation, and said zone having a height of at least 0.025″.

3. An aggregate cutting saw chain for cutting aggregate structures comprising:
a segment defining a length and width and having abrading elements embedded in a matrix material and adapted to be secured to upper edges of a carrier link or links of the saw chain;
said segment as secured to said carrier link or side links and in unused condition having an upper surface of non-flat surface configuration varying in height to perform higher and lower surface areas and which wears during use to a flat surface configuration, said upper surface non-flat configuration and continuing to said flat surface configuration defining a zone of reduced area of engagement;
said abrading elements dispersed throughout the matrix material and in unused condition lying under the upper surface of non-flat surface configuration, said abrading elements in the higher surface areas exposed for cutting as the matrix material at said higher surface areas is removed in an initial cutting operation, said zone of reduced area of engagement and said abrading elements cooperatively sized and configured to achieve exposure of abrading elements for cutting with no greater than 30% of the upper surface area of the segment being engaged with the aggregate structure in start up cutting.

4. An aggregate cutting saw chain as defined in claim 1 wherein the segment has a side profile where the upper surface is an inverted shallow “v” shape providing a ramping effect as the segment engages the aggregate structure.

5. A saw chain for engaging and cutting an aggregate structure comprising:
a segment of a cutter link embodied in the saw chain including diamonds embedded in a matrix material and configured into a block-like form having parallel side walls and end walls and with a defined outer surface area as measured between said side walls and end walls, and as so configured, the matrix material being sufficiently soft so as to wear away when engaged with an aggregate structure to thereby expose the diamonds at the defined outer surface area;
said defined outer surface area configured in an unused state to have varying heights with a highest portion including an embedded uppermost diamond, and further configured whereby engagement of said segment surface area with the aggregate structure, and continuing until said uppermost diamond is sufficiently exposed for cutting produces a surface area of engagement with said aggregate structure that is no greater than 30% of the defined outer surface area.

6. A saw chain as defined in claim 5 wherein the highest portion of the segment is centered front to back and defines a peak, the surface area forward and rearward of said peak sloping downwardly respectively to the leading edge and to a trailing edge.

7. A saw chain as defined in claim 6 wherein said segment is symmetrical and can be reversed to provide the leading edge as the trailing edge and vice versa.

8. A saw chain as defined in claim 6 wherein the saw chain comprises pivotally connected side link pairs and center links, certain of the side link pairs defining upper support edges and the segment supported on said upper support edges, a drive link preceding said certain of the side link pairs and including a guard extension projected upwardly and defining a guard tip positioned in adjacent relation to the leading edge of the segment, said guard tip located at a height positioned between the leading edge and the peak portion of the cutting head with said link pairs and center links of the saw chain entrained in a straight line.

9. A saw chain as defined in claim 8 wherein the guard tips define a lateral plane that extends above the front and rear edges of the cutting head and through the peak portion and the volume of the peak portion that extends above the lateral plane is substantially equal to the void between the leading and trailing edges and the lateral plane.
